(19) United States
(12) Patent Application Publication
(10) Pub. No.: US 2015/0094387 A1
(43) Pub. Date: Apr. 2, 2015

(54) Use of Thickening Agents as Polyurethane Amine Catalyst Diluents

(71) Applicants: Eugene P. Wiltz, JR., The Woodlands, TX (US); Donald Ridgway, Spring, TX (US); Jennifer Chavez, Houston, TX (US); Frank Rodriguez, The Woodlands, TX (US); Robert A. Grigsby, JR., Spring, TX (US); Gwynne Whitcombe, Sterrebeck (BE)

(72) Inventors: Eugene P. Wiltz, JR., The Woodlands, TX (US); Donald Ridgway, Spring, TX (US); Jennifer Chavez, Houston, TX (US); Frank Rodriguez, The Woodlands, TX (US); Robert A. Grigsby, JR., Spring, TX (US); Gwynne Whitcombe, Sterrebeck (BE)

(73) Assignee: Huntsman Petrochemical LLC, The Woodlands, TX (US)

(21) Appl. No.: 14/237,173

(22) PCT Filed: Aug. 10, 2012
(86) PCT No.: PCT/US2012/050273

§ 371 Date: Mar. 20, 2014

Related U.S. Application Data
(60) Provisional application No. 61/522,349, filed on Aug. 11, 2011.

(51) Int. Cl. C08G 18/18

(52) U.S. Cl. CPC C08G 18/18
USPC 521/128; 502/167; 502/159

(57) ABSTRACT

The present disclosure relates to an amine catalyst composition for producing polyurethane foam. The amine catalyst composition includes an amine catalyst and a diluent containing a thickening agent and water. The use of such a diluent, in place of conventional glycols, reduces raw material and processing costs as well as environmental concerns during the production of polyurethane foam.

### CROSS-REFERENCE TO RELATED APPLICATION

This application claims priority to U.S. Provisional Application Ser. No. 61/522,349, filed Aug. 11, 2011.

### STATEMENT REGARDING FEDERALLY SPONSORED RESEARCH OR DEVELOPMENT

Not applicable.

### FIELD OF THE INVENTION

The present disclosure is directed to an amine catalyst composition for use in the production of polyurethane foam. In particular, the amine catalyst composition of the present disclosure includes an amine catalyst and a diluent comprising a thickening agent and water.

### BACKGROUND OF THE INVENTION

Polyurethane foams are widely known and used in a variety of applications, including, but not limited to, in the automotive and housing industry. These foams are produced by the reaction of a polyisocyanate with a polyol in the presence of various additives. One such additive is an amine catalyst which is used to accelerate blowing (reaction of water with polyisocyanate to generate CO₂) and gelling (reaction of polyol with polyisocyanate).

Conventional amine catalysts used in polyurethane foam production generally have low, water-like viscosities. Because of their low viscosities, the transfer of these catalysts during manufacture becomes extremely difficult. Therefore, they are frequently combined with a diluent to adjust the composition's viscosity to provide for easier handling and transfer.

For example, in commercial flexible slabstock polyurethane foam production, the amine catalyst is transferred to a foam mixing head from a holding tank via a mechanical pump. A majority of these pumps are designed to transfer liquids having a viscosity greater than 50 cps. However, amine catalyst viscosities are generally much lower than this and therefore cannot be accurately and consistently transferred. One way to overcome this is to combine the amine catalyst with higher viscosity diluents, particularly diols such as ethylene glycol, propylene glycol or dipropylene glycol, which have viscosities in the range of about 75-300 cps. In some cases, up to 90% of the desired diol may be combined with the amine catalyst to reach the final desired composition viscosity. However, the use of these diols adds raw material and processing costs as well as generates environmental concerns.

It is an object of the present disclosure therefore to provide new diluents for use in amine catalyst compositions which are both cost-effective and environmentally friendly.

### SUMMARY OF THE INVENTION

The present disclosure relates to a diluent for use in amine catalyst compositions which is both cost effective and environmentally friendly. According to one embodiment the diluent contains a thickening agent and water.

In a further embodiment, the present disclosure provides an amine catalyst composition for use in the production of polyurethane foam which includes an amine catalyst and the diluent of the present disclosure.

In still another embodiment, there is provided a polyurethane foam formulation which includes a compound containing an isocyanate functional group, an active hydrogen-containing compound and the amine catalyst composition of the present disclosure.

### DETAILED DESCRIPTION OF THE INVENTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical object of the article. By way of example, “an epoxy” means one epoxy or more than one epoxy.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The present disclosure is generally directed to novel amine catalyst compositions which include a diluent containing a thickening agent and water and to flexible polyurethane foam products, such as slab, molded and microcellular polyurethane foam, made using such compositions. It has been surprisingly found that use of a thickening agent and water as a diluent, in place of glycols, leads to a significant reduction in raw material costs. Additionally, the use of the diluents of the present disclosure provides a significant reduction in processing costs as compared to conventional diluents since they do not require the storing, transferring and mixing of large amounts of glycols. Finally, the diluents according to the present disclosure are safe, non-hazardous and preferably non-flammable which eliminates the environmental concerns associated with the use of glycol diluents. As used herein, the term “non-flammable” is intended to describe a diluent with a flash point of at least 37.8° C., more preferably at least 45° C., most preferably at least 50° C. The limit of a flash point of at least 37.8° C. for non-flammable liquids is defined in NFPA 30, the Flammable and Combustible Liquids Code as issued by National Fire Protection Association, 1996 edition, Massachusetts USA.

The amine catalyst compositions of the present disclosure catalyze the reaction between a compound containing an isocyanate functional group and an active hydrogen-containing compound, for example, an alcohol, polyol, amine or water in the production of polyurethane foam. Accordingly, the amine catalyst composition may catalyze the gelling reaction of hydroxyls with isocyanate to form polyurethane and/or the blowing reaction of water with isocyanate to release carbon dioxide during the production of foamed polyurethane.

According to one embodiment, the amine catalyst composition comprises at least one amine catalyst. The amine catalyst may be any compound containing a primary, secondary or tertiary amine group. In some embodiments, the amine catalyst may contain from two to twenty carbon atoms. In one particular embodiment, the amine catalyst composition contains at least about 5% by weight of the amine catalyst, based on the total weight of the amine catalyst composition. In another embodiment, the amine catalyst composition contains at least about 10% by weight of the amine catalyst, based on the total weight of the amine catalyst composition. In yet another embodiment, the amine catalyst composition contains no more than about 99% by weight of the amine catalyst, based on the total weight of the amine catalyst composition. In a further embodiment, the amine catalyst composition contains no more than about 95% by weight of the amine catalyst, based on the total weight of the amine catalyst composition. In another embodiment, the amine catalyst composition contains no more than about 90% by weight of the amine catalyst, based on the total weight of the amine catalyst composition. In another embodiment, the amine catalyst composition contains from about 95% by weight to about 5% by weight of the amine catalyst, based on the total weight of the amine catalyst composition. In yet another embodiment, the amine catalyst composition contains from about 90% by weight to about 10% by weight of the amine catalyst, based on the total weight of the amine catalyst composition.

In one particular embodiment, the amine catalyst is a tertiary amine compound. The tertiary amine compound may be any compound possessing catalytic activity for the reaction between a polyol and a polyisocyanate and which contains at least one tertiary amine group. Representative tertiary amine compounds include, but are not limited to, dimethylaminopropylemine, dimethylaminoethoxypropylamine, pentamethyldiethylylenetriamine, trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl)ether, morpholine, N-substituted morpholines, such as N-methyl or N-ethyl morpholine, 4,4′-(oxydi-2,1-ethanediyl)bis, triethylenediamine, pentamethyl diethylene triamine, dimethyl cyclohexyl amine, N-cetyl N,N-dimethyl amine, N-coco-morpholine, N,N-dimethyl aminomethyl N-methyl ethanol amine, N,N,N′-trimethyl-N′-hydroxyethyl bis(aminoethyl)ether, N,N-bis(3-dimethylaminopropyl)N-isopropanolamine, (N,N-dimethyl)amino-ethoxy ethanol, N,N,N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis(propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, N,N-bis(3-dimethylaminopropyl)-N-isopropanolamine, 1,3-propanediamine, 1,2-ethylene piperidine, methyl-hydroxyethyl piperazine, dimethylaminopropyl-S-triazine, bisdimethylaminopropylurea and mixtures thereof.

Other amine catalysts which may be used in the present disclosure may be found in Appendix D in “Dow Polyurethanes Flexible Foams” by Herrington et al. at pages D.1-D.23 (1997), which is incorporated herein by reference. Examples of commercially available amine catalysts include JEFFCAT® brand catalysts, such as JEFFCAT® ZF-20 catalyst (available from Huntsman Petrochemical LLC). Further examples may be found in “JEFFCAT® Amine Catalysts for the Polyurethane Industry” version JCT-0910 which is incorporated herein by reference.

In addition to the amine catalyst, the amine catalyst composition further contains a diluent comprising a thickening agent and water. The thickening agent may be any natural organic material or synthetic organic material that is able to gelate in water and raise the viscosity of the amine catalyst composition to the appropriate level. In one particular embodiment, the amine catalyst composition contains at least about 1% by weight of the diluent, based on the total weight of the amine catalyst composition. In another embodiment, the amine catalyst composition contains at least about 10% by weight of the diluent, based on the total weight of the amine catalyst composition. In still another embodiment, the amine catalyst composition contains no more than about 90% by weight of the diluent, based on the total weight of the amine catalyst composition. In yet another embodiment the amine catalyst composition contains no more than about 80% by weight of the diluent, based on the total weight of the amine catalyst composition In another embodiment, the amine catalyst composition contains from about 1% by weight to about 90% by weight of the diluent, based on the total weight of the amine catalyst composition. In still another embodiment, the amine catalyst composition contains from about 10% by weight to about 80% by weight of the diluent, based on the total weight of the amine catalyst composition.

In one embodiment, the thickening agent comprises a cellulose ether. The cellulose ethers of the present disclosure are preferably water-soluble. As used herein, the term “water-soluble” means that at least 1 gram, and preferably at least 2 grams, of the cellulose ether is soluble in 100 grams of distilled water at 25° C. and 1 atmosphere. The extent of water-solubility can be varied by adjusting the extent of ether substitution on the cellulose ether and by adjusting the substitution level of the hydrophobic substituents, when present. Techniques for varying the water solubility of cellulose ethers are known to those skilled in the art.

In one embodiment, the cellulose ether is an alkyl cellulose ether, a hydroxyalkyl cellulose ether, a carboxyalkyl cellulose ether, a hydroxyalkylpolyoxyalkyl cellulose ether or combinations thereof. The alkyl cellulose ether, hydroxyalkyl cellulose ether, carboxyalkyl cellulose ether, or hydroxyalkylpolyoxyalkyl cellulose ether may have C₁₋₁₀ alkyl radicals.

Examples of alkyl cellulose ethers, include, but are not limited to, methyl cellulose, ether and ethyl cellulose ether; examples of hydroxyalkyl cellulose ethers, include, but are not limited to, hydroxyethyl cellulose ether and hydroxypropyl cellulose ether; examples of carboxyalkyl cellulose ethers include, but are not limited to, carboxymethyl cellulose ether; and examples of mixed ethers of cellulose include, but are not limited to, hydroxyethyl methyl cellulose ether, hydroxypropyl methyl cellulose ether, and hydroxyethyl ethyl cellulose ether. Water soluble salts of these cellulose ethers, such as sodium carboxymethylcellulose or sodium hydroxyethylcellulose, may also be used.

In some embodiments, the cellulose ether may have an average degree of substitution “DS” of from 0.1 to 3.0, more preferably from 0.5 to 1.5. In addition, the molecular weight of the cellulose ether may range from about 10,000 grams per gram mole to about 2×10⁶ grams per gram mole and in further embodiments may range from about 70,000 grams per gram mole to about 1×10⁶ grams per gram mole. As used herein, the term “molecular weight” means weight average molecular weight. Methods for determining weight average molecular weight of cellulose ethers are known to those skilled in the art, for example, by low angle laser light scattering.

In still further embodiments, the viscosity of the cellulose ether may range from about 5 centipoise to about 6000 centipoise, preferably from about 100 centipoise to about 3000 centipoise. Unless otherwise indicated, as used herein the term “viscosity” refers to the viscosity of a 1 weight percent aqueous solution of the cellulose ether measured at 25° C. with a Brookfield viscometer. Such viscosity measuring techniques are known in the art and are described in ASTM D 2364-89. The average particle size of the cellulose ethers is not critical, but may range from about 0.01 microns to about 1000 microns and more preferably from about 50 about to 400 microns.

In another embodiment, the thickening agent comprises starch. Starch is a natural carbohydrate chain comprising polymerized sugar molecules (glucose). Starch is formed in granules that contain two types of glucose polymers: the single-chain amylose and the branched amylopectin. In general, starch granules are insoluble in cold water. However, if the outer membrane is broken by, e.g., grinding, the granules can swell in cold water to form a gel. In hot water, the granules quickly swell then burst, resulting in gelation of the starch by the surrounding water. Gelatinization results from the binding of water molecules within the tangled mass of amylose and amylopectin chains through hydrogen bonding.

Although starch is produced in many plants, the most important sources are seeds of cereal grains, such as corn, waxy corn, wheat, sorghum, rice, and waxy rice, tubers, such as potatoes, roots such as tapioca (i.e., cassava and manioc), sweet potato, and arrowroot, and the pith of the sago palm. If in a native state, such starches are known as “unmodified” starch. If gelated in water, they become “gelated” or “gelatinized” starch. If gelated and then dried to form a powder, they are “pregelated” or “pregelatinized” starch. If chemically altered by, e.g., etherification, esterification, oxidation, acid hydrolysis, amination, enzyme conversion, cross-linking, polymerization, etc., they are known as “modified” starches. Typical modified starches include esters, such as the acetate and the half-esters of dicarboxylic acids/anhydrides, particularly the alkenylsuccinic acids/anhydrides; ethers, such as the hydroxyethyl and hydroxypropyl starches; oxidized starches, such as those oxidized with hypochlorite; starches reacted with cross-linking agents, such as phosphorus oxychloride, epichlorohydrin, hydrophobic cationic epoxides, and phosphate derivatives prepared by reaction with sodium or potassium orthophosphate or tripolyphosphate, and combinations thereof. Modified starches also include seagel, long-chain alkylstarches, dextrins, amine starches, and dialdehyde starches.

Since pregelatinized and many modified starches gelate in cold water, such starches can be added to the amine catalyst composition to increase the viscosity without heating. In other embodiments, unmodified starches may be used due to their lower cost and because they yield comparable compositions.

According to one embodiment, the starch is potato starch, which quickly gelates and reaches a maximum viscosity at about 65° C., which then decreases somewhat as the mixture is heated further. Waxy corn starch, which acts in a similar fashion, may also be used. Both potato starch and waxy corn starch yield a high viscosity fluid when gelated. However, any starch that has similar swelling characteristics may be used and are generally preferred over those that swell in two or more stages. Nevertheless, it will be appreciated that any starch may be used within the scope of this disclosure as a thickening agent.

Other natural organic material thickening agents include, but are not limited to, organic clays, carrageenan, cassia gum, diutan gum, gellan gum, alginic acid, phycocolloids, agar, gum arabic, guar gum, locust bean gum, gum karaya, whelun gum, xanthan gum, tragacanth, prolamine derived from corn (i.e. Zein), collagen (i.e. derivatives extracted from animal connective tissue such as gelatin and glue), and casein (i.e. derived from cow's milk).

Synthetic organic material thickening agents include, but are not limited to, clays, nanoclays, polyvinyl pyrrolidone, polyethylene glycol, polyvinyl alcohol, polyvinylmethyl ether, polyacrylic acids, polyacrylic acid salts, polyvinyl acrylic acids, polyvinyl acrylic acid salts, polyacrylamides, ethylene oxide polymers, polylactic acid and latex (which is a broad category that includes a variety of polymerizable substances foiined in a water emulsion; an example is styrene-butadiene copolymer).

Representative commercially available thickening agents include, but are not limited to, the KELZAN® line of xanthan gums (available from CP Kelco) and VANZAN® line of xanthan gums (available from R.T. Vanderbilt Co.); diutan gums such as GEOVIS® XT, KELCO-VIS™ and KELCO-CRETE® diutan gums (all available from CP Kelco); KELCOGEL® line of gellan gums (available from CP Kelco); GENUVISCO® carrageenan gum (available from CP Kelco), NOVEGUM® line of hydrocolloids (available from Noveon, Inc.); natural or synthetic clays including bentonite, hectorite, smectite and other silicates such as available grades of BENTOLITE®, CLAYTONE®, and GELWHITE® bentonites, PERMON® smectites, CLOISITE® magnesium aluminum silicates, LAPONITE® silicates and GARAMITE® silicates (all available from Southern Clay Products, Inc.) and available grades of OPTIGEL® bentonites, hectorites, smectites and other clays (all from Sud-Chemie Group); homopolymers or copolymers of acrylic acid, e.g., those which may be neutralized with a salt including associative or non-associative thickeners such as ACUSOL® line of acrylate polymers (available from Rohm & Haas Co.) or those which may be crosslinked (e.g., with a polyalkenyl polyether) including CARBOPOL® line of polymers (available from Noveon, Inc.); PEMULEN® copolymer (from Noveon, Inc.); METHOCEL® line of cellulose ethers (available from Dow Chemical Company) and XDS cellulose ether (from Dow Chemical Company); and hydroxypropyl cellulose ethers such as KLUCEL® cellulose ethers (available from Hercules Inc.).

The amount of thickening agent combined with water may vary depending on factors such as the desired dilution level, the desired viscosity build rate following mixing and the desired degree of thickening. In some embodiments, the amount of thickening agent combined with water, expressed as solids, may, for example, range from about 0.1% by weight to about 20% by weight of thickening agent, based on the total weight of thickening agent and water. In other embodiments, the amount of thickening agent combined with water, expressed as solids, may range from about 0.5% by weight to about 15% by weight of thickening agent, based on the total weight of thickening agent and water. In still other embodiments, the amount of thickening agent combined with water, expressed as solids, may range from about 1% to about 10% by weight of thickening agent, based on the total weight of thickening agent and water. In yet other embodiments, the amount of thickening agent combined with water is an amount such that the viscosity of the diluent (at 25° C.) is greater than about 50 cps, and in some embodiments, greater than about 55 cps.

In still another embodiment, the amine catalyst composition may further contain one or more non-amine catalysts, in addition to the amine catalyst mentioned before. The non-amine catalyst is a compound (or mixture thereof) having catalytic activity for the reaction of an isocyanate group with a polyol or water, but is not a compound falling within the description of the amine catalyst above. Examples of such additional non-amine catalysts include, for example:
i) tertiary phosphines, such as trialkylphosphines and dialkylbenzylphosphines;
ii) chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni;
iii) acidic metal salts of strong acids, such as ferric chloride, stannic chloride, stannous chloride, antimony trichloride, bismuth nitrate and bismuth chloride;
iv) strong bases, such as alkali and alkaline earth metal hydroxides, alkoxides and phenoxides;
v) alcoholates and phenolates of various metals, such as Ti(OR)₄, Sn(OR)₄ and Al(OR)₃ where R is alkyl or aryl, and the reaction products of the alcoholates with carboxylic acids, beta-diketones and 2-(N,N-dialkylamino) alcohols;
vi) alkaline earth metal, Bi, Pb, Sn or Al carboxylate salts; and
vii) tetravalent tin compounds, and tri- or pentavalent bismuth, antimony or arsenic compounds.

The present disclosure also provides a method for making the amine catalyst composition which includes providing a diluent comprising a thickening agent and water and contacting an amine catalyst and diluent whereby the amine catalyst is dissolved into the diluent.

The amine catalyst compositions may be used in a catalytically effective amount to catalyze the reaction between a compound containing an isocyanate functional group and an active hydrogen-containing compound for making polyurethane foam. A catalytically effective amount of the amine catalyst composition may range from about 0.01-10 parts per 100 parts of active hydrogen-containing compound, preferably from about 0.05-5 parts per 100 parts of active hydrogen-containing compound. Thus, in another embodiment, the present disclosure provides a polyurethane foam formulation comprising a compound containing an isocyanate functional group, an active hydrogen-containing compound, a catalytically effective amount of the amine catalyst composition and optional auxiliary components.

In one embodiment, the compound containing an isocyanate functional group is a polyisocyanate and/or an isocyanate-terminated prepolymer.

Polyisocyanates include those represented by the formula Q(NCO)ₙ where n is a number from 2-5, preferably 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms.

Examples of polyisocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI); norbornane diisocyanates; m- and p-isocyanatophenyl sulfonylisocyanates; perchlorinated aryl polyisocyanates; modified polyisocyanates containing carbodiimide groups, urethane groups, allophnate groups, isocyanurate groups, urea groups, or biruret groups; polyisocyanates obtained by telomerization reactions; polyisocyanates containing ester groups; and polyisocyanates containing polymeric fatty acid groups. Those skilled in the art will recognize that it is also possible to use mixtures of the polyisocyanates described above.

Isocyanate-terminated prepolymers may also be employed in the preparation of the polyurethane foam. Isocyanate-terminated prepolymers may be prepared by reacting an excess of polyisocyanate or mixture thereof with a minor amount of an active-hydrogen containing compound as determined by the well known Zerewitinoff test as described by Kohler in “Journal of the American Chemical Society,” 49, 3181 (1927).

In one embodiment, the active hydrogen-containing compound is a polyol. Polyols suitable for use in the present disclosure include, but are not limited to, polyalkylene ether polyols, polyester polyols, polymer polyols, a non-flammable polyol such as a phosphorus-containing polyol or a halogen-containing polyol. Such polyols may be used alone or in suitable combination as a mixture.

Polyalkylene ether polyols include poly(alkylene oxide) polymers such as poly(ethylene oxide) and poly(propylene oxide) polymers and copolymers with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols include, but are not limited to, those produced by reacting a dicarboxylic acid with an excess of a diol, for example, adipic acid with ethylene glycol or butanediol, or reaction of a lactone with an excess of a diol such as caprolactone with propylene glycol.

In addition to polyalkylene ether polyols and polyester polyols, polymer polyols are also suitable for use in the present disclosure. Polymer polyols are used in polyurethane foams to increase the foam's resistance to deformation, for example, to improve the load-bearing properties of the foam. Examples of polymer polyols include, but are not limited to, graft polyols or polyurea modified polyols (Polyharnstoff Dispersion polyols). Graft polyols comprise a triol in which vinyl monomers are graft copolymerized. Suitable vinyl monomers include, for example, styrene, or acrylonitrile. A polyurea modified polyol, is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrin or trichlorobutylene oxide.

In addition to the amine catalyst composition, the compound containing an isocyanate functional group and the active hydrogen-containing compound, the polyurethane foam formulation may further include one or more auxiliary components. Examples of auxiliary components include, but are not limited to, cell stabilizers, anionic surfactants chain extenders, pigments, fillers, flame retardants, thermally expandable microspheres, blowing agents or any combination thereof.

Cell stabilizers may include, for example, silicon surfactants or anionic surfactants. Examples of suitable silicon surfactants include, but are not limited to, polyalkylsiloxane, polyoxyalkylene polyol-modified dimethylpolysiloxane, alkylene glycol-modified dimethylpolysiloxane, or any combination thereof.

Suitable anionic surfactants include, but are not limited to, salts of fatty acids, salts of sulfuric acid esters, salts of phosphoric acid esters, sulfonates, or any combination thereof.

Examples of chain extenders include, but are not limited to, compounds having hydroxyl or amino functional group, such as glycols, amines, diols, and water. Further non-limiting examples of chain extenders include ethylene glycol, propylene glycol, 1,4-butanediol, 1,3-butanediol, 1,5-pentanediol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclo-hexanol, 1,2-diaminoethane, toluenediamine, or any mixture thereof.

Pigments may be used to color code the polyurethane foams during manufacture, to identify product grade, or to conceal yellowing. Pigments may include any suitable organic or inorganic pigments. For example, organic pigments or colorants include, but are not limited to, azo/diazo dyes, phthalocyanines, dioxazines, or carbon black. Examples of inorganic pigments include, but are not limited to, titanium dioxide, iron oxides, or chromium oxide.

Fillers may be used to increase the density and load bearing properties of polyurethane foams. Suitable fillers include, but are not limited to, barium sulfate or calcium carbonate.

Flame retardants can be used to reduce the flammability of polyurethane foams. For example, suitable flame retardants include, but are not limited to, chlorinated phosphate esters, chlorinated paraffins, or melamine powders.

Thermally expandable microspheres include those containing a (cyclo)aliphatic hydrocarbon. Such microspheres are generally dry, unexpanded or partially unexpanded microspheres consisting of small spherical particles with an average diameter of typically 10 to 15 micron. The sphere is formed of a gas proof polymeric shell (consisting e.g. of acrylonitrile or PVDC), encapsulating a minute drop of a (cyclo)aliphatic hydrocarbon, e.g. liquid isobutane. When these microspheres are subjected to heat at an elevated temperature level (e.g. 150° C. to 200° C.) sufficient to soften the thermoplastic shell and to volatilize the (cyclo)aliphatic hydrocarbon encapsulated therein, the resultant gas expands the shell and increases the volume of the microspheres. When expanded, the microspheres have a diameter 3.5 to 4 times their original diameter as a consequence of which their expanded volume is about 50 to 60 times greater than their initial volume in the unexpanded state. Examples of such microspheres are the EXPANCEL®-DU microspheres which are marketed by AKZO Nobel Industries of Sweden.

A blowing agent may also be added to the foam formulation, which may either be an exothermic or endothermic blowing agent or a combination of both.

Any known blowing agent used in the preparation of foam may be used in the present disclosure as a blowing agent. Examples of chemical blowing agents include gaseous compounds such as nitrogen or carbon dioxide, gas (e.g. CO₂) forming compounds such as azodicarbonamides, carbonates, bicarbonates, citrates, nitrates, borohydrides, carbides such as alkaline earth and alkali metal carbonates and bicarbonates e.g. sodium bicarbonate and sodium carbonate, ammonium carbonate, diaminodiphenylsulphone, hydrazides, malonic acid, citric acid, sodium monocitrate, ureas, azodicarbonic methyl ester, diazabicylooctane and acid/carbonate mixtures. Examples of physical blowing agents include volatile liquids such as chlorofluorocarbons, partially halogenated hydrocarbons or non-halogenated hydrocarbons like propane, n-butane, isobutane, n-pentane, isopentane and/or neopentane.

A general polyurethane flexible foam formulation having a 1-4 lb/ft³ density (e.g. automotive seating) containing an amine catalyst composition according to the present disclosure may comprise the following components in parts by weight (pbw):

| Flexible Foam Formulation | pbw |
|---|---|
| Polyol | 20-100 |
| Surfactant | 0.3-3 |
| Blowing Agent | 1-6 |
| Crosslinker | 0-3 |
| Amine Catalyst Composition | 0.2-2.5 |
| Isocyanate Index | 70-115 |

The amount of compound containing an isocyanate functional group is not limited, but it generally will be within those ranges known to those skilled in the art. An exemplary range given above is indicated by reference to Isocyanate Index which is defined as the number of equivalents of isocyanate divided by the total number of equivalents of active hydrogen, multiplied by 100.

In yet another embodiment, the present disclosure provides a method for producing polyurethane foam which comprises contacting a compound containing an isocyanate functional group, an active hydrogen-containing compound and optional auxiliary components in the presence of the amine catalyst composition.

### EXAMPLES

### Example 1

A diluent according to the present disclosure was produced by combining 2 grams of a cellulose ether with 98 grams of distilled deionized water, which had been heated to about 60° C. The mixture was then stirred for about 30 minutes, cooled to room temperature, and then stirred again for an additional 30 minutes. The viscosity of the diluent was measured using a Brookfield viscometer and was determined to be 35 cps at 25° C. An amine catalyst (JEFFCAT® ZF-20) was then added to the diluent to form an amine catalyst composition containing 75.5% by weight water, 1.5% by weight cellulose ether and 23% by weight amine catalyst. The viscosity of the amine catalyst composition was measured using a Brookfield viscometer and determined to be 57 cps at 25° C.

The viscosity of a comparative amine catalyst composition was then measured. The comparative amine catalyst composition contained 23% by weight of his-dimethylamino ethylether and 77% by weight dipropylene glycol. The viscosity of the comparative amine catalyst composition was 36 cps at 25° C. Thus, the use of 1.5% by weight of a cellulose ether, in place of 77% by weight dipropylene glycol, reduced the amount of diluent raw materials used and increased the viscosity of the amine catalyst composition to an optimum level for processing.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An amine catalyst composition for use in the production of polyurethane foam comprising:
(a) an amine catalyst; and
(b) diluent comprising a thickening agent and water.

2. The amine catalyst composition of claim 1 wherein the amine catalyst is compound containing a primary, secondary or tertiary amine group and from two to twenty carbon atoms.

3. The amine catalyst composition of claim 1 wherein the amine catalyst is a tertiary amine compound.

4. The amine catalyst composition of claim 3 wherein the tertiary amine compound is selected from dimethylaminopropylamine, dimethylaminoethoxypropylamine, pentamethyldiethylylenetriamine, trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl)ether, morpholine, N-methyl morpholine, N-ethyl morpholine, 4,4′-(oxydi-2,1-ethanediyl)bis, triethylenediamine, pentamethyl diethylene triamine, dimethyl cyclohexyl amine, N-cetyl N,N-dimethyl amine, N-coco-morpholine, N,N-dimethyl aminomethyl N-methyl ethanol amine, N,N,N′-trimethyl-N′-hydroxyethyl bis(aminoethyl)ether, N,N-bis(3-dimethylaminopropyl)N-isopropanolamine, (N,N-dimethyl)amino-ethoxy ethanol, N,N,N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis(propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, N,N-bis(3-dimethylaminopropyl)-N-isopropanolamine, 1,3-propanediamine, 1,2-ethylene piperidine, methyl-hydroxyethyl piperazine, dimethylaminopropyl-S-triazine, bisdimethylaminopropylurea and a mixture thereof.

5. The amine catalyst composition of claim 1 wherein the thickening agent comprises a cellulose ether.

6. The amine catalyst composition of claim 5 wherein the cellulose ether comprises an alkyl cellulose ether, a hydroxyalkyl cellulose ether, a carboxyalkyl cellulose ether, a hydroxyalkylpolyoxyalkyl cellulose ether or a combination thereof.

7. The amine catalyst composition of claim 5 wherein the cellulose ether is selected from methyl cellulose ether, ethyl cellulose ether, hydroxyethyl cellulose ether, hydroxypropyl cellulose ether, carboxymethyl cellulose ether; hydroxyethyl methyl cellulose ether, hydroxypropyl methyl cellulose ether, hydroxyethyl ethyl cellulose ether, sodium carboxymethylcellulose, sodium hydroxyethylcellulose and a mixture thereof.

8. The amine catalyst composition of claim 1 wherein the thickening agent comprises starch.

9. The amine catalyst composition of claim 1 wherein the thickening agent comprises a natural organic material selected from clay, carrageenan, cassia gum, diutan gum, gellan gum, alginic acid, a phycocolloid, agar, gum arabic, guar gum, locust bean gum, gum karaya, whelun gum, xanthan gum, tragacanth, prolamine derived from corn, collagen and casein.

10. The amine catalyst composition of claim 1 wherein the thickening agent comprises a synthetic organic material selected from clay, a nanoclay, polyvinyl pyrrolidone, polyethylene glycol, polyvinyl alcohol, polyvinylmethyl ether, a polyacrylic acid, a polyacrylic acid salt, a polyvinyl acrylic acid, a polyvinyl acrylic acid salt, a polyacrylamide, an ethylene oxide polymer, polylactic acid and latex.

11. An amine catalyst composition for use in the production of polyurethane foam comprising: (a) an amine catalyst; and (b) from about 1% by weight to about 90% by weight, based on the total weight of the composition, of a diluent comprising a thickening agent and water.

12. The amine catalyst composition of claim 11 wherein the diluent comprises from about 1% by weight to about 10% by weight of the thickening agent, based on the total weight of thickening agent and water.

13. A polyurethane foam formulation comprising a compound containing an isocyanate functional group, an active-hydrogen-containing compound, a catalytically effective amount of the amine catalyst composition according to claim 1 and optional auxiliary components

14. The polyurethane foam formulation of claim 13 wherein the catalytically effective amount ranges from about 0.01-10 parts of amine catalyst composition per 100 parts of active hydrogen-containing compound.

15. A method for producing a polyurethane foam comprising contacting a compound containing an isocyanate functional group, an active hydrogen-containing compound and optional auxiliary components in the presence of the amine catalyst composition according to claim 1.
